(19) United States
(12) Patent Application Publication
(10) Pub. No.: US 2004/0129038 A1
(43) Pub. Date: Jul. 8, 2004

(54) Secure gun display

(76) Inventor: Todd L. Vercoe, Cheney, WA (US)

Correspondence Address: LEE & HAYES, PLLC, 421 W. RIVERSIDE AVE, STE 500, SPOKANE, WA, 99201, US

(21) Appl. No.: 10/736,027

(22) Filed: Dec. 15, 2003

Related U.S. Application Data
(63) Continuation-in-part of application No. 10/152,203, filed on May 20, 2002, now abandoned.

(51) Int. Cl. E05B 69/00; E05B 73/00

(52) U.S. Cl. 70/58; 70/62

(57) ABSTRACT

Described herein is a secure gun display, comprising a restraint for holding a gun through a trigger guard of the gun and around a stock of the gun, wherein the restraint provides increased security by approximating the configuration of a thumb and forefinger of a human hand in a trigger-pulling position.

### RELATED APPLICATION

This application is a continuation-in-part of copending U.S. patent application Ser. No. 10/152,203 entitled “LOCKING DISPLAY GUN RACK” by the same inventor, incorporated herein for all that it discloses and teaches, and claims benefit of priority for common subject matter.

### TECHNICAL FIELD

The subject matter relates generally to firearm safety and display and more specifically to a secure gun display.

### BACKGROUND

Firearms are vulnerable to theft and misuse because they are valuable, portable, and desirable for trading, recreation, self-protection, and criminal activity. Since bearing arms is a Constitutional right, many Americans proudly display favorite hunting, military, and antique guns. Display of a gun, however, such as the proverbial mounting of a family rifle above the fireplace, can make the displayed gun even more vulnerable to theft or misuse.

The tension between the wide availability of guns due to the right to bear arms and the vulnerability of guns to theft and misuse has resulted in many types of gun locks, racks, and cases to secure the guns. Unfortunately, these security measures can provide too little safety for a displayed gun, or, the unsightliness provided by the security measure defeats the purpose of displaying the gun. Some conventional gun racks lack security features, such as a holding member through the trigger loop. Many gun racks touted as secure are relatively easy to disassemble or are quite easy to pry, saw, or cut apart, as those who have lost guns to these devices can attest. Other security gun racks can be foiled by disassembling the gun. This happens when a professional burglar desires the gun or more commonly when a depressed person or a child in the home has extended time to figure out how to dismantle the gun, freeing the gun from the security device.

Various conventional gun racks have security flaws and many conventional gun racks have the distinct disadvantage of being designed for a particular model or size of gun. A conventional gun rack may hold a particular gun securely but lacks a universal holding mechanism or at least lacks a mechanism for preventing insertion of a gun that the gun rack cannot hold securely. In other words, it is often possible to place a smaller or larger gun in a conventional gun rack than is intended to be held securely by the design of the conventional gun rack. For example, in some conventional gun racks, such as those described in U.S. Pat. No. 5,887,730 to St. George, U.S. Pat. No. 4,624,372 to Brolin, U.S. Pat. No. 3,618,785 to Newman, U.S. Pat. No. 5,078,279 to Hancock et al., etc., placing too small a gun in a shackle of the St. George rack (in a curved enclosing member of the Brolin rack, in a locking member of the Newman rack, or in a holding unit of the Hancock rack) would defeat one or more security features of these gun racks. Many of these conventional gun racks allow a tool such as bar or chain cutter to be inserted around the part of the shackle or other holding member, especially if a smaller than anticipated gun is introduced. A secure gun rack should not allow a bar cutter to be inserted around a holding member of the gun rack, despite the size of the gun being secured. Even thick and hardened metal bar stock used in automotive steering wheel locks, such as THE CLUB, can be cut by a portable bar or chain cutter-if the cutter can gain access around the metal bar stock.

On the other hand, a gun may be too large for the St. George, Brolin, Newman, Hancock, etc., gun racks. With respect to the St. George and other racks, for example, a mounted scope on some gun models would preclude the use of these racks. The gun and scope would be too large for the shackle, or would compromise security if the shackle was placed around an unintended part of the gun in order to avoid the presence of the scope. With respect to the Brolin and other racks, a wider or thicker stock would preclude the use of these racks or necessitate an unintended positioning of the gun. In each of the above-cited patent references, if the securing shackle or loop proceeds through a gun's trigger guard the shackle or loop goes straight up over the breech of the weapon eliminating many guns from fitting in the rack: guns with scopes will not fit, due to lack of clearance; guns with bolt actions will not fit, as the bolt is in a vertical line with the trigger guard; guns with wide breeches will not fit due to the required size of the shackle or loop. If the conventional shackle or loop avoids the trigger guard to secure only around the stock (as in several of the above-cited patent references) the security of the gun rack is severely reduced as the stock can easily be cut and replaced or on many models the gun itself can be dismantled and removed. Conversely, if the conventional gun rack secures only the trigger guard of the gun the trigger guard itself can easily be removed on many models.

Locking a gun in an unmovable safe may provide good security but does not allow display. For displayed guns in the home, children, thieves, and the emotionally distraught may defeat conventional gun locks, racks, and gun cases to cause subsequent tragedy and loss.

### FIGURES

FIG. 1 is a perspective view of an example secure gun display, according to one example implementation.

FIG. 2 is an exploded view of an example secure gun display, according to one example implementation.

FIG. 3 is side cutaway view of an example stock mount assembly and lock, according to one example implementation of the subject matter.

FIG. 4 is an exploded view of an example secure gun display, according to one example implementation.

FIG. 5 is a partially exploded view of an example secure gun display.

### DETAILED DESCRIPTION

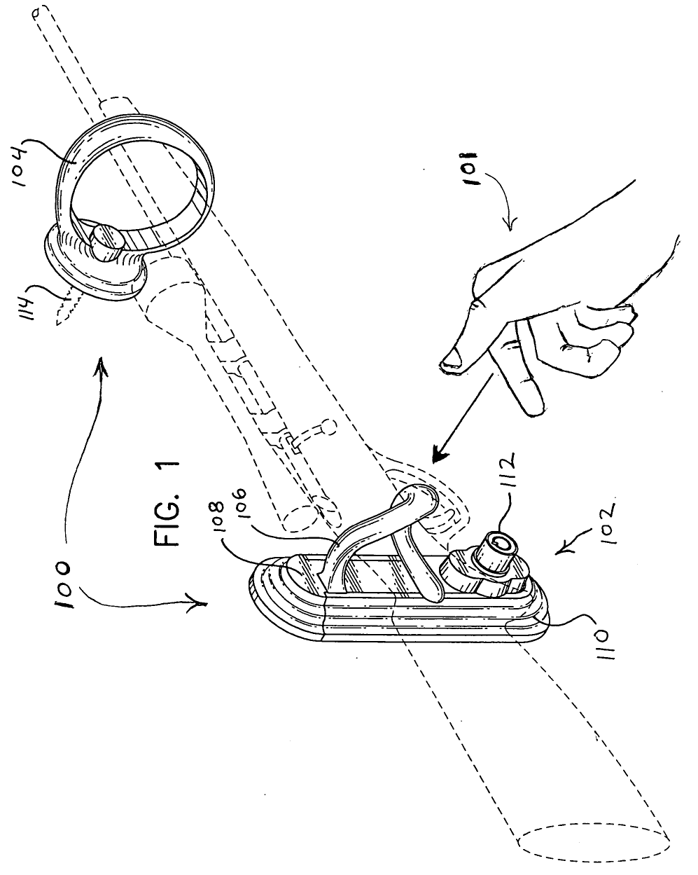

FIG. 1 shows an exemplary implementation of a secure gun display 100 that provides safety by exploiting a common design feature of most guns. Despite differences in the many characteristics that a gun can possess-model, style, materials, dimensions, size, shape, etc.—most guns are universally designed to be held and fired by a human hand in a “trigger-pulling position” 101, as shown in FIG. 1. A user's hand can assume an almost infinite number of shapes and positions, but most guns are designed to be held by a hand in the trigger-pulling position 101, that is, between the thumb and forefinger with the thumb wrapped “up” around the side of the gun stock or over the top of a gun stock, e.g., behind a gun breech, and the forefinger wrapped “down” and “around” in front of a trigger. Thus, most guns have a gun section near the trigger where the dimensions are very consistent and designed to be held by a user's hand in the trigger-pulling position 101. Even though human hands differ somewhat in size, the relevant dimensions of variously-sized hands in the trigger-pulling position 101 do not vary much with respect to those parts of a hand that hold and fire a gun. Hence gun-makers do not vary much from one-size-fits-all dimensions for the part of a gun that the firing hand grips. Although the parts of a gun around which the thumb and forefinger wrap in order to pull a trigger are almost universally the same across different guns, still, the consistently dimensioned parts form an unusual curve, i.e., the curve of a hand in the trigger-pulling position 101. Additionally, scopes and other mounted accessories superior to the stock, trigger, and/or breech of a gun are universally situated to avoid interference with the presence of a hand in the trigger-pulling position 101.

An exemplary restraint 106 illustrated in FIG. 1 is a member that emulates or approximates the relative configuration and curvature of a thumb and forefinger of a hand in a trigger-pulling position 101. Geometrically, an exemplary restraint 106 has a shape similar to a short segment of a helix, a non-planar spiral. On a 3-dimensional axis system, an exemplary restraint 106 corkscrews through all three dimensions: in one implementation, the curvature of an exemplary restraint 106 can be reproduced by beginning a curve along one directional axis, gradually changing the direction vector of the curve to an adjacent axis, gradually changing the direction vector of the curve to the remaining (third) axis, but before proceeding far along the third axis, looping around to retrace along the first axis and continuing the curve until proceeding backwards in the opposite direction of the third axis. In other words, viewing a gun from a side of the gun (now called the front) the curvature of an exemplary restraint 106 begins near the top rear of the gun typically above and behind a trigger, proceeds straight out towards the observer, curves down, then curves forward towards the barrel end of the gun (and toward a trigger guard) while still curving down, begins to stop curving down while beginning to curve back towards the rear side of the gun, continues curving until proceeding straight back towards the stock end of the gun.

The helical curvature of an exemplary restraint 106 surrounds the part of each secured gun that has consistent dimensions across many types and sizes of guns. Therefore, the exemplary restraint 106 remains snug around a gun, preventing large bar cutting tools from gaining access to the exemplary restraint 106, while allowing guns that have mounted scopes and other accessories to be secured without interfering with the scope or other accessory. Conventional gun racks cannot provide these advantages. In short, an exemplary locking gun rack that uses an exemplary restraint 106 can accommodate many different styles and sizes of guns and accessories and afford a high degree of security. The exemplary restraint 106 emulates the shape of a person's hand and fits on the gun as the hand would. Guns come in many shapes and sizes but the dimensions around which an exemplary restraint 106 fits must remain relatively constant as guns must be made to accommodate the average person's hand.

In another aspect of the subject matter, the curves of an exemplary restraint 106, as opposed to simple rectangular shackles of conventional gun racks, also deflect many of the types of tools used to defeat locks and safety devices.

In its various implementations, the secure gun display 100 provides security and can have an appearance that accentuates the firearm being displayed, thereby avoiding the obtrusive and unattractive appearance expected in gun racks that try to provide more than nominal security. In general, the secure gun display 100 secures a gun such that disassembling the gun to foil the secure gun display 100 would prove difficult or impossible.

In its implementations, the secure gun display 100 can possess an elegant streamlined smoothness imparting a beauty to the displayed gun equal to or surpassing that of the gun itself. The visibility of the secure gun display 100 is kept to a minimum, so that an observer sees mostly the gun, not the secure gun display 100. The streamlined smoothness is also a utility feature making the secure gun display 100 difficult or impossible to pry apart or breach in any way. When assembled to hold a gun, the various parts of the secure gun display 100 become one or more smooth, tough assemblies (e.g., 102, 104) with no appreciable places for a cutter, saw, or pry-bar to gain a foothold.

In some implementations, a barrel loop 104 may be used for a long gun, such as a rifle, carbine, or shotgun. If the barrel loop 104 is used, the parts of the secure gun display 100 continue to form smooth, thief-resistant assemblies when displaying a gun that are highly resistant to prying, cutting, sawing, and other dismantling of the secure gun display 100 or the gun itself.

In one example implementation, a secure gun display 100 has a stock mount assembly 102 and a barrel loop 104 assembly. The rifle depicted in dotted lines is not part of the subject matter but is included to show context and relative proportion. The stock mount assembly 102 further includes an exemplary restraint 106, a face plate 108, and a wall piece 110. A lock 112 may be included on the face plate 108 or elsewhere to secure the face plate 108 and the exemplary restraint 106 to the wall piece 110. The face place 108 and the wall piece 110 are just one example of a device for securing the exemplary restraint 106 to a secure surface. Other techniques for securing the exemplary restraint 106 to a secure surface could be used. The barrel loop 104 is illustrated as a single piece including a mounting attachment 114. In variations, however, the barrel loop 104 may be made of a composite of parts including, of course, detachable mounting hardware.

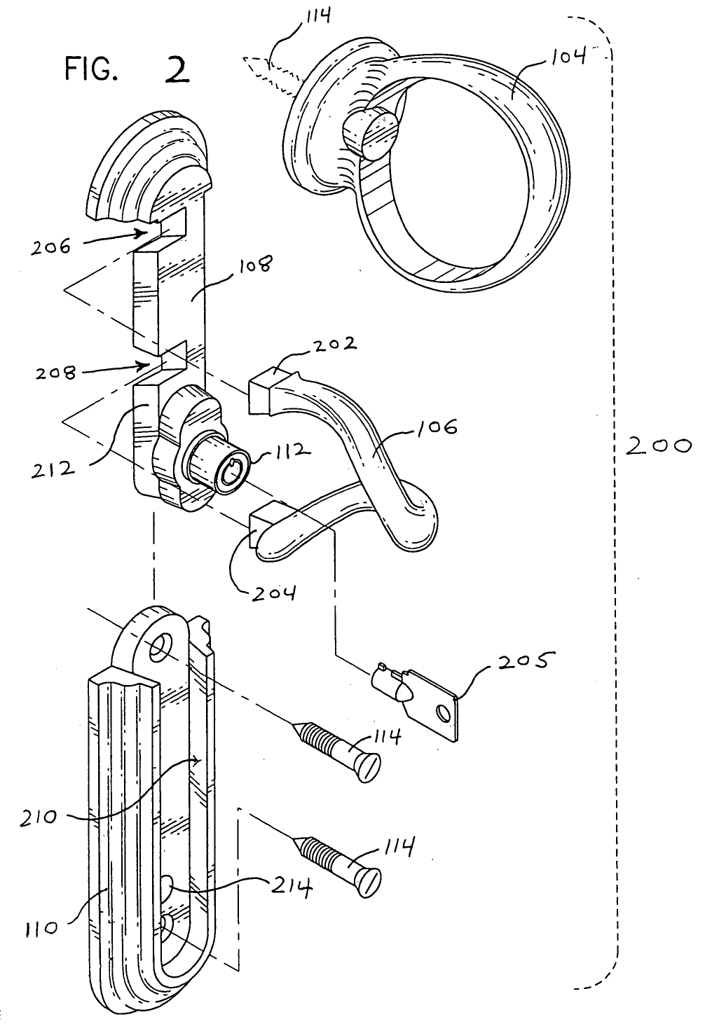

FIG. 2 shows an exploded view 200 of one example implementation of a secure gun display 100. The exemplary restraint 106 can have a first tapered key end 202 and a second tapered key end 204. The exemplary restraint 106 can be passed around the stock of a gun through a trigger guard on the gun and the first tapered key end 202 and second tapered key end 204 can be inserted into tapered keyways 206, 208 in the face plate 108. The exemplary restraint 106 may be constructed of cut-resistant, saw-resistant and pry-resistant material such as brass alloy or case-hardened steel. The material is cast, molded, shaped, etc. into a curved configuration that emulates a hand in the trigger-pulling position 101. In one implementation the exemplary restraint 106 is cast or molded in a single piece, or shaped from a single bar. In variations fasteners, such as the tapered key ends 202, 204, can be attached after the remainder of the exemplary restraint 106 is manufactured.

A face plate 108, after being coupled with an exemplary restraint 106, is secured, e.g., by inserting into a channel 210 in the wall piece 110. In the illustrated implementation, the face plate 108 has tapered edges 212 to slide into a taper-edged channel 210 in the wall piece 110.

In one implementation, a tapered fit between the face plate 108 and the wall piece 110 renders the stock mount assembly 102 highly resistant to prying apart. A pry bar edge cannot penetrate a crack between the face plate 108 and the wall piece 110 to achieve any leverage for prying apart the secure gun display 100. The tapered key ends 202, 204 of the exemplary restraint 106 participate in the tapered fit between the face plate 108 and the wall piece 110 and in the illustrated implementation form part of the tapered edge 212 of the face plate 108 when the tapered key ends 202, 204 are inserted in the keyways 206, 208 of the face plate 108.

A lock 112 may be coupled with the face plate 108, as will be discussed more fully below. In one implementation, the lock 112 uses a key 205 that is resistant to lock picking.

In one implementation, the barrel loop 104 is an independent member although in some implementations the barrel loop 104 could be integrated in a single rack with the wall piece 110. In the illustrated implementation, the barrel loop 104 has a mounting attachment, such as a screw, bolt, or wall anchor. If a screw is used for the mounting attachment 114, the presence of a gun barrel inside the barrel loop 104 eliminates the possibility of unscrewing the barrel loop 104 from a surface to remove the gun.

Mounting attachments can also be used for the wall piece 110, as when the particular implementation uses a wall piece 110 separated from the barrel loop 104. The mounting attachment 114 can be, for instance, a screw, bolt, or wall anchor. Other mounting attachments 114 are feasible depending on the surface to which the secure gun display 100 will be attached.

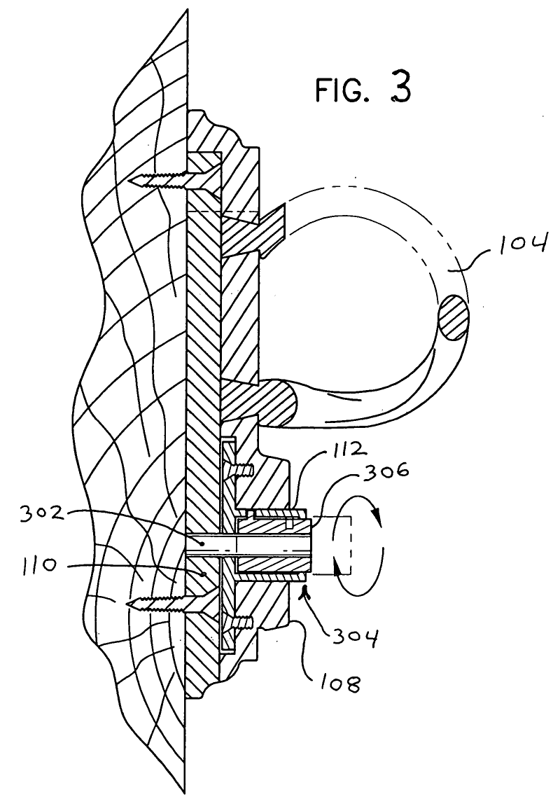

FIG. 3 shows one example implementation of a lock 112 coupled with a face plate 108. The lock 112 may extend a bolt 302 into a hole 214 in the wall piece 110 to secure the face plate 108, the exemplary restraint 106, (and the gun) to the wall piece 110. Other types of locks 112 or locking mechanisms may be used. One type of lock 112 that may be employed retracts flushly with a surface 304 on the face plate 108 so that when locked only the key-receiving surface 306 of the lock 112 is exposed. The retracted lock 112, flush with the surface 304 on the face plate 108, is highly resistant to prying open. A pry tool large enough to achieve significant leverage on the lock 112 cannot be inserted in any crack space around the retracted lock 112.

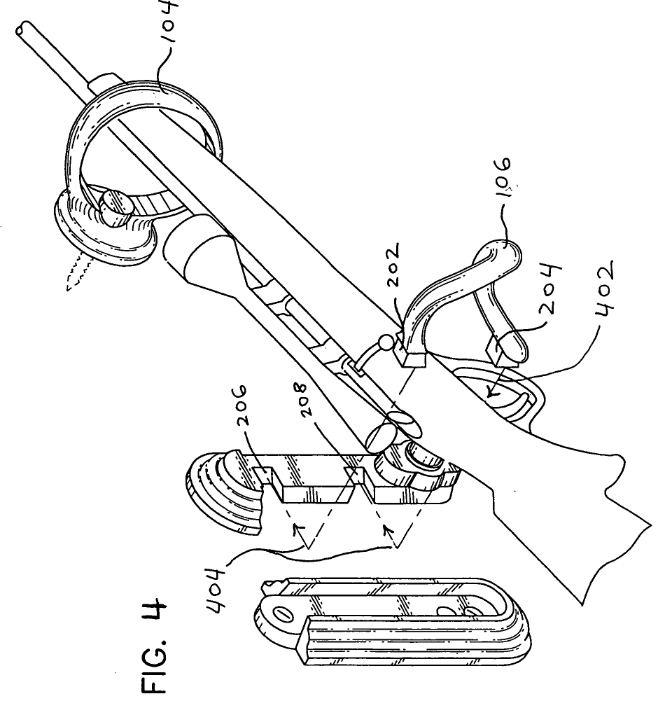

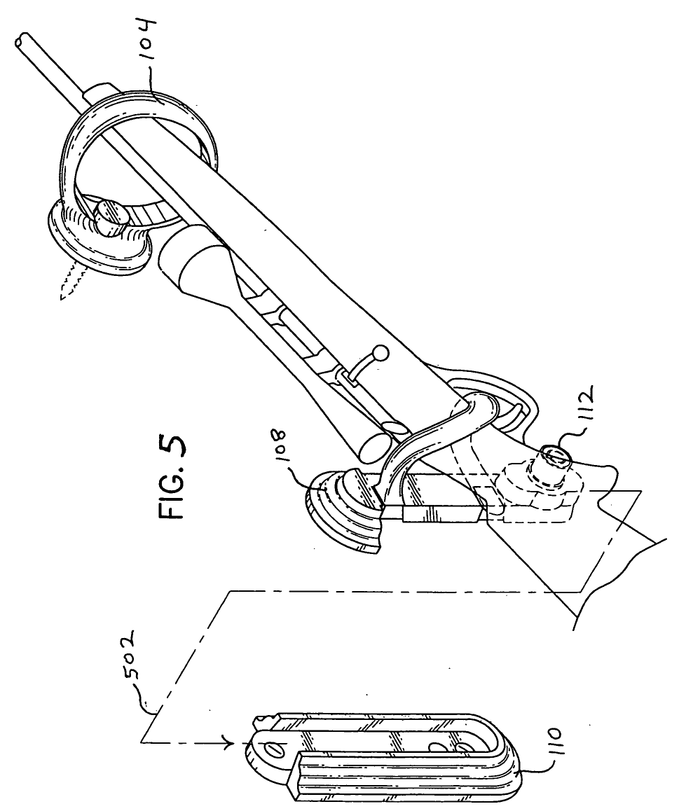

FIGS. 4 and 5 depict an example method of using a secure gun display 100. In FIG. 4, one end of an exemplary restraint 106, in this case including tapered key ends 202, 204, is inserted through a trigger guard of a gun (402). The example tapered key ends 202, 204 are secured in keyways 206, 208 in a face plate 108 (404). In FIG. 5, the face plate 108 is secured to the wall piece 110 (502). In one implementation, the face plate 108 has tapered edges that slide into a tapered channel in the wall piece 110. The method may further comprise securing the face plate 108 to the wall piece 110 with a lock 112. In some implementations, the method may further comprise inserting the barrel of a long gun through a barrel loop 104.

The methods and apparatuses are presented as examples of an exemplary secure gun display 100 that includes an exemplary restraint 106. Modifications can be made without departing from the basic scope of the subject matter. The particular implementations that have been presented herein are not provided to limit the subject matter but to illustrate it. The scope of the subject matter is not to be determined by the specific examples provided above but by the claims below.

1. A secure gun display, comprising:
a restraint for holding a gun through a trigger guard of the gun and around a stock of the gun, wherein the restraint approximates a shape of a thumb and a forefinger of a human hand in a trigger-pulling position; and
a means for securing the restraint to a secure surface.

2. The secure gun display as recited in claim 1, wherein a curvature of the restraint comprises at least part of a non-planar spiral.

3. The secure gun display as recited in claim 1, wherein a curvature of the restraint comprises at least part of a helix.

4. The secure gun display as recited in claim 1, wherein a curvature of the restraint corkscrews through three dimensions.

5. The secure gun display as recited in claim 4, wherein a curvature of the restraint comprises a curve in a 3-dimensional axis system along a first axis that changes direction to a second axis that changes direction to a third axis.

6. The secure gun display as recited in claim 1, wherein a curvature of the restraint curves from a location near a top of a gun down and forward to a trigger guard of the gun and then continues curving through the trigger guard and then continues curving from the trigger guard towards the stock end of the gun.

7. The secure gun display of claim 1, wherein the means for securing includes a lock.

8. The secure gun display of claim 1, wherein the restraint is made of at least one of cut-resistant, saw-resistant and pry-resistant material.

9. The secure gun display of claim 1, wherein the shape of the restraint includes continuous curves to deflect tools.

10. A restraint for securing a gun, comprising:
a member to hold a gun through a trigger guard of the gun and around a stock of the gun,
wherein the member approximates a shape of a thumb and a forefinger of a human hand in a trigger-pulling position, and
wherein the member includes fasteners to secure the member to a secure surface.

11. The restraint for securing a gun as recited in claim 10, wherein a curvature of the member comprises at least part of a non-planar spiral.

12. The restraint for securing a gun as recited in claim 10, wherein a curvature of the member comprises at least part of a helix.

13. The restraint for securing a gun as recited in claim 10, wherein a curvature of the member corkscrews through three dimensions.

14. The restraint for securing a gun as recited in claim 13, wherein a curvature of the member comprises a curve in a 3-dimensional axis system along a first axis that changes direction to a second axis that changes direction to a third axis.

15. The restraint for securing a gun as recited in claim 10, wherein a curvature of the member curves from a location near a top of a gun down and forward to a trigger guard of the gun and then continues curving through the trigger guard and then continues curving from the trigger guard towards the stock end of the gun.

16. The restraint as recited in claim 10, wherein the member comprises one of a cut-resistant, saw-resistant, and pry-resistant material.

17. The restraint as recited in claim 10, wherein the member includes continuous curves to deflect tools.

18. A method of making a secure gun display, comprising:
shaping a restraint for securing a gun through a trigger guard of the gun and around a stock of the gun to emulate a shape of a thumb and a forefinger of a human hand in a trigger-pulling position; and
providing fasteners to secure the restraint to a secure surface.

19. A method of making a restraint for a secure gun display, comprising:
obtaining a material, wherein the material is at least one of cut-resistant, saw-resistant, and pry-resistant; and
shaping the material to emulate a shape of a thumb and a forefinger of a human hand in a trigger-pulling position to place through a trigger guard of a gun and around a stock of the gun.

20. The method as recited in claim 19, wherein a curvature imparted to the material curves from a location near a top of a gun down and forward to a trigger guard of the gun and then continues curving through the trigger guard and then continues curving from the trigger guard towards the stock end of the gun.
